(19) United States
(12) Patent Application Publication
(10) Pub. No.: US 2006/0057324 A1
(43) Pub. Date: Mar. 16, 2006

(54) Note-taking device for use with textual material

(76) Inventors: Alice C. Phillips, Murrells Inlet, SC (US); Frederick J. Fleming, Matthews, NC (US)

Correspondence Address: Alice C. Phillips, 347 Lawton Hall Drive, Murrells Inlet, SC, 29576, US

(21) Appl. No.: 10/711,411

(22) Filed: Sep. 16, 2004

(51) Int. Cl. B32B 33/00

(52) U.S. Cl. 428/40.1

(57) ABSTRACT

A note-taking device for use with various textual materials such as books, magazines, documents, publications, or the like. The note-taking device has a note-taking surface with a layer of releasable pressure-sensitive adhesive strip on the top portion of its rear surface for repositionable attachment to any page of the textual material. Since the strip is relegated only the top portion of the rear surface, the bottom edge of the note-taking surface is easily lifted to access data on the page without necessitating removal of the note-taking device there from. Additionally, a locator tab is provided on the upper edge of the note-taking surface such that when the device is repositionably engaged on the page, the tab protrudes beyond the outer edge of the page. Thus the note-taking device may be easily located by a user when the textual material is closed or even when the textual material is not currently opened to the page on which the note-taking device is engaged.

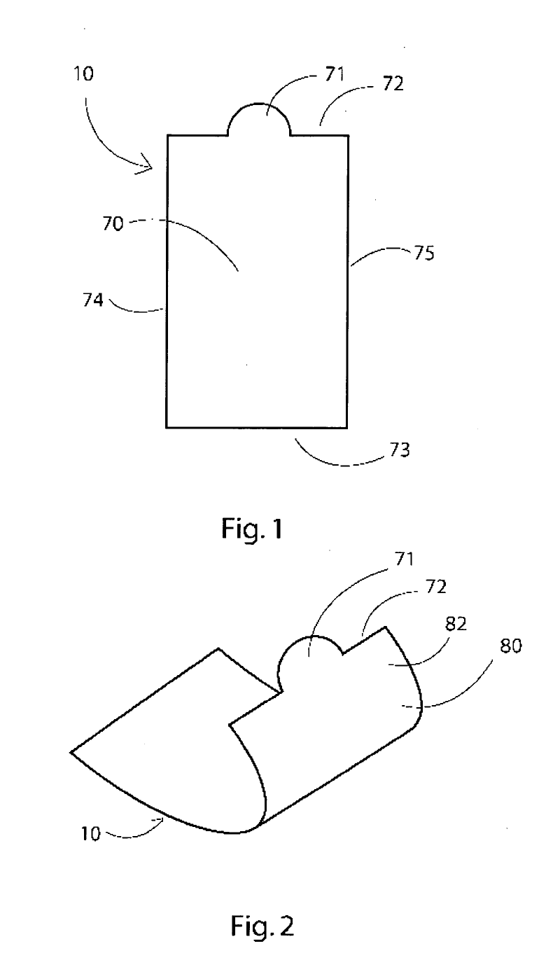

As shown in FIGS. 1 through 4, a note-taking device with integrally attached locator tab embodying a preferred embodiment of the instant invention is designated by reference numeral 10. The device 10 generally comprises a writing portion 70 having an upper edge 72, lower edge 73, and left 74 and right 75 side edges with a locator tab portion 71 integrally attached to the upper edge 72 thereof. Preferably, the writing portion 70 and locator tab 71 are die-cut from one sheet of paper stock or flexible polymeric material during manufacture. The front surface of the writing portion forms a writing surface which is adapted for receipt of personal notes created thereon by a user with a typical writing utensil such as a pen or pencil.

Optionally, permanent indicia (not shown) may be formed on the front surface of the writing portion 70 in order to facilitate the organization of user created notes thereon. For example, a plurality of evenly spaced horizontal lines which extend between the two side edges (74 and 75) may be incorporated or even vertical lines whose cooperation therewith forms boxes for defining predetermined areas of the front surface for specific user input. Additionally, alpha-numeric characters or symbols may be added to provide further structure for the user created notes.

As shown best in FIG. 2, the rear surface 80 of the writing portion has a layer of pressure-sensitive adhesive 82 disposed proximate the upper edge thereof that is preferably adapted for releasable attachment to a page of textual material. It is important to note that the rear surface of the locator tab 71 is void of any pressure-sensitive adhesive material for reasons to be described hereinafter.

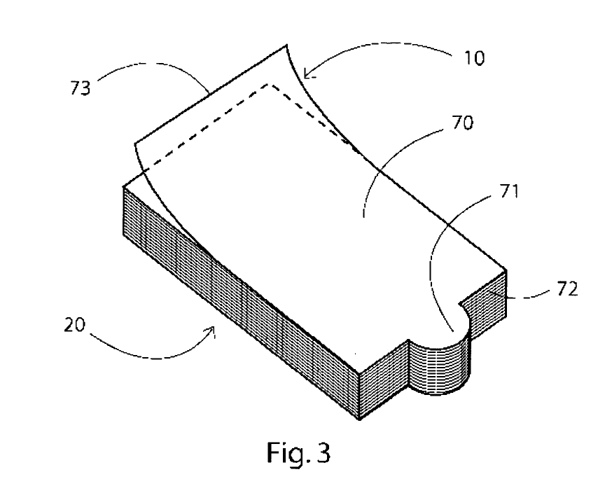

FIG. 3 illustrates the note-taking device 10 stacked in plurality to create a pad 20 form for retail packaging or dispensing. The pressure-sensitive adhesive strip 82 as shown in FIG. 2 allows the device 10 to adhere to another device 10 immediately beneath it. The same is true of subsequent devices thereby allowing the notes to be arranged in such a stacked form. Notes can be removed individually from the pad 20 by lifting the bottom edge 73 of the device and peeling toward the upper edge 72.

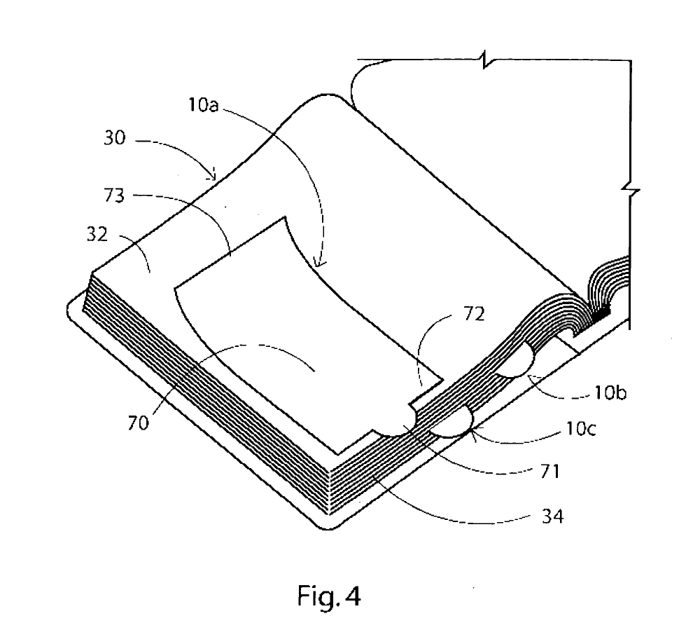

FIG. 4 illustrates several of the devices (10a, 10b, and 10c) in operative engagement releasably attached to pages of a conventional book 30. The device 10a is affixed to the page 32 of the book 30 by pressing its upper edge 72 onto the page 32, wherein the pressure-sensitive adhesive strip 82, as shown in FIG. 2, releasably secures the note 10a in place. Such placement allows the locator tab 71 to protrude beyond the edge of the page 32. Other devices (10b, and 10c), shown in operative engagement on other pages 34 of the book 30, illustrate how the note-taking device 10 of the present invention may be readily located by the user when the book is closed or the book is not currently opened to the page on which the note-taking device is engaged. It is important to note that locator tab should preferably be void of any portion of the pressure-sensitive adhesive layer in order to alleviate any possible undesirable effects caused by a “tacky” surface extending beyond the confines of the book's structure.

Thus the note-taking device 10 of the present invention provides a novel means of user incorporation of personal notes into various forms of textual material such as books, magazines, publications, or the like without writing directly onto the printed page thereof. Personal notes may be taken over a plurality of the pages of the textual material and may be subsequently easily located for later retrieval. Since only a relatively small portion of the rear surface 80 proximate the upper edge 72 of the writing portion 70 has a layer of the pressure-sensitive adhesive 82 thereon, indicia on the page of the book may be easily accessed by simply lifting the lower edge thereof without necessitating complete removal of the device 10 from the page. Additionally, subsequent notes can be placed on their respective pages in a staggered pattern to allow for easier access to the locator tab 71 thereof. Abbreviated notations may be made on the front surface of each locator tab 71 in order to differentiate among multiple note-taking devices engaged on the book.

Although the present embodiment describes a writing portion which is generally rectangular in shape, it is to be appreciated that the writing portion may also be formed into other geometric shapes such as squares, triangles, trapezoids, frusto-circles, and the like. The only limitation for the shape of the writing portion being that the upper edge 72 be generally linear in order to conform to the linear edge of a page of a typical book. Additionally, the locator tab 71 which is shown in the drawings as frusto-circular in shape may also be formed into other geometric shapes.

The preferred embodiment describes a locator tab 71 having a width which is less than the width of the writing portion 70 in order to minimize the amount of sheet material which extends beyond the edge of the page of a book or other type of textual material. However, it is contemplated that the locator tab may have sufficient width to extend the entire distance between the side edges (74 and 75) of the writing portion. The width of the writing portion 70 is defined as the distance between the left 74 and right 75 side edges. Also, the preferred embodiment describes a locator tab 71 which is disposed substantially at the central portion of the width of the writing portion 70; however, the locator tab 71 may also be disposed proximate either the left 74 or right 75 side edge without departing from the spirit or scope of the invention.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

What is claimed is:

1. A note-taking device for use with textual materials having a plurality of pages, wherein each said page has an outer edge, said note-taking device comprising:
a writing sheet having generally flat front and rear surfaces, and upper and lower edges, said front surface is adapted for the creation of notes thereon by a user;
a layer of releasable pressure-sensitive adhesive over a portion of said rear surface proximate said upper edge thereof, said layer being adapted for repositionable attachment to said one page of said textual material; and,
a locator tab having a front tab surface and a rear tab surface, said locator tab is integrally attached to the upper edge of said writing sheet, wherein the rear and front tab surfaces of said locator tab being void of pressure-sensitive adhesive thereon, whereby said locator tab is adapted to protrude beyond the outer edge of said page when repositionably attached thereto.

2. A plurality of note-taking devices having the structure set forth in claim 1 which are repositionably attached together along the upper edge thereof via said layer of releasable pressure-sensitive adhesive in order to form a pad, wherein the rear surface of each said note-taking device lies adjacent the front surface of another said note-taking device there below.

3. The note-taking device for use with textual materials of claim 1, wherein said writing sheet is generally rectangular in shape.

4. The note-taking device for use with textual materials of claim 1, wherein said locator tab is generally frusto-circular in shape.

5. The note-taking device for use with textual materials of claim 1, wherein said locator tab is disposed substantially at the central portion of said upper edge.

6. The note-taking device for use with textual materials of claim 1, wherein said writing sheet and said locator tab are integrally formed from one piece of material.

7. The note-taking device for use with textual materials of claim 6, wherein said material is paper or a flexible polymer.

8. The note-taking device for use with textual materials of claim 1, wherein the front surface of said writing sheet has permanent indicia printed thereon.

9. A pad comprising a plurality of note-taking sheets for use with textual materials, wherein said textual materials having a plurality of pages and each said page having an outer edge, each note-taking sheet comprising:
a writing sheet portion having generally flat front and rear surfaces, and upper and lower edges, said front surface is adapted for the creation of notes thereon by a user;
a layer of releasable pressure-sensitive adhesive over a portion of said rear surface proximate said upper edge thereof, said layer being adapted for repositionable attachment to said one page of said textual material; and,
a locator tab portion having a front tab surface and a rear tab surface, said locator tab portion is integrally attached to the upper edge of said writing sheet portion, wherein the rear and front tab surfaces of said locator tab portion being void of pressure-sensitive adhesive thereon, whereby said locator tab portion is adapted to protrude beyond the outer edge of said page when repositionably attached thereto;
wherein said plurality of note-taking sheets are repositionably attached together along the upper edge thereof via said layer of releasable pressure-sensitive adhesive in order to form said pad, and wherein the rear surface of each said note-taking sheet lies adjacent the front surface of another said note-taking sheet there below.

10. The note-taking sheet of claim 9, wherein said writing sheet portion is generally rectangular in shape.

11. The note-taking sheet of claim 9, wherein said locator tab portion is generally frusto-circular in shape.

12. The note-taking sheet of claim 9, wherein said locator tab is disposed substantially at the central portion of said upper edge.

13. The note-taking sheet of claim 9, wherein said writing sheet portion and said locator tab portion are integrally formed from one piece of material.

14. The note-taking sheet of claim 13, wherein said material is paper or a flexible polymer.

15. The note-taking sheet of claim 9, wherein the front surface of said writing sheet portion has permanent indicia printed thereon.
